(19) United States
(12) Patent Application Publication
(10) Pub. No.: US 2025/0275635 A1
(43) Pub. Date: Sep. 4, 2025

(54) ADJUSTABLE SEAT

(71) Applicant: Gulfstream Aerospace Corporation, Savannah, GA (US)

(72) Inventors: Timothy O'Hara, Savannah, GA (US); Josh Tatum, Savannah, GA (US); Jeremiah Mallette, Savannah, GA (US); Joe Guthrie, Savannah, GA (US)

(73) Assignee: Gulfstream Aerospace Corporation, Savannah, GA (US)

(21) Appl. No.: 18/594,518

(22) Filed: Mar. 4, 2024

(51) Int. Cl. A47C 31/12; B64D 11/06

(52) U.S. Cl. CPC A47C 31/126; B64D 11/0639; B64D 11/0647

(57) ABSTRACT

An adjustable seat includes a seat body. The adjustable seat further includes a plurality of inflatable bladders coupled with the seat body, each inflatable bladder of the plurality of inflatable bladders having a rectangular cross-section in a direction perpendicular to a longitudinal axis of the inflatable bladder. The adjustable seat further includes a source of a pressurized air fluidly coupled with the plurality of inflatable bladders. The adjustable seat further includes a user input device configured to receive an input from a user. The adjustable seat still further includes a controller that is communicatively coupled with the user input device and that is operatively coupled with the source of the pressurized air. The controller configured to obtain the input from the user input device and to control the source of the pressurized air to direct the pressurized air into the plurality of inflatable bladders in response to receiving the input.

### TECHNICAL FIELD

The present invention relates generally to seats and more particularly, to seats that are equipped with inflatable bladders to provide adjustable levels of comfort to a seat occupant.

### BACKGROUND

Conventional seats including, but not limited to seats disposed onboard aircraft, may be configured to adjust cushioning support for a seat occupant through the use of inflatable bladders. Other seats may employ inflatable bladders for the purpose of providing a massage function for the seat occupant. However, very few seats provide both inflatable cushioning support and a massage function. Of those few seats that do provide both inflatable cushioning support and a massage function, none use a single set of inflatable bladders to accomplish both functions.

In addition, with respect to the provision of cushioning support, all conventional adjustable seats that provide inflatable cushioning employ “dumb” systems. That is to say, all conventional inflatable cushioning support systems lack the ability to determine where an occupant requires additional cushioning support and further lack the ability to distribute such additional cushioning support to where the occupant needs it.

Further, conventional inflatable cushioning support systems use flat bladders having a circular configuration. This circular configuration requires that each individual bladder be positioned at a distance from one another within the seat that accommodates their respective diameters. As each flat, circular bladder is inflated, the diameter of the bladder decreases and its height increases. This diminishing diameter results in the bladders being spaced apart from one another when they are inflated. This, in turn, results in an inability of the inflated bladders to provide as focused and as concentrated a level of cushioning support as may be desired by a seat occupant.

Accordingly, it is desirable to provide an adjustable seat that addresses the concerns expressed above. Furthermore, other desirable features and characteristics will become apparent from the subsequent summary and detailed description and the appended claims, taken in conjunction with the accompanying drawings and the foregoing technical field and background.

### BRIEF SUMMARY

Various non-limiting embodiments of an adjustable seat are disclosed herein.

In a first non-limiting embodiment, the adjustable seat includes, but is not limited to, a seat body. The adjustable seat further includes, but is not limited to, a plurality of inflatable bladders that are coupled with the seat body. Each inflatable bladder of the plurality of inflatable bladders has a rectangular cross-section in a direction that is perpendicular to a longitudinal axis of the inflatable bladder. The adjustable seat further includes, but is not limited to, a source of a pressurized air fluidly coupled with the plurality of inflatable bladders. The adjustable seat further includes, but is not limited to, a user input device that is configured to receive an input from a user. The adjustable seat still further includes, but is not limited to, a controller that is communicatively coupled with the user input device and that is operatively coupled with the source of the pressurized air. The controller is configured to obtain the input from the user input device and to control the source of the pressurized air to direct the pressurized air into the plurality of inflatable bladders in response to receiving the input.

In another non-limiting embodiment, the adjustable seat includes, but is not limited to, a seat body. The adjustable seat further includes, but is not limited to, a plurality of inflatable bladders that are coupled with the seat body. Each inflatable bladder of the plurality of inflatable bladders has a rectangular cross-section in a direction perpendicular to a longitudinal axis of the inflatable bladder. The adjustable seat further includes, but is not limited to, a source of a pressurized air. The adjustable seat further includes, but is not limited to, a plurality of conduits fluidly coupling the source of the pressurized air with the plurality of inflatable bladders. The adjustable seat further includes, but is not limited to, a user input device that is configured to receive an input from a user. The adjustable seat further includes, but is not limited to, a sensor that is configured to detect a change in a weight distribution of a seat occupant along the seat body. The adjustable seat still further includes, but is not limited to, a controller that is communicatively coupled with the user input device and with the sensor and that is operatively coupled with the source of the pressurized air and with the plurality of conduits. The controller is configured to obtain the input from the user input device and to control the source of the pressurized air to direct the pressurized air into the plurality of inflatable bladders in response to receiving the input. The controller is further configured to obtain information from the sensor that is indicative of the change in weight distribution of the seat occupant, to select a selected inflatable bladder from the plurality of inflatable bladders based on the information, and to control the source of the pressurized air and the plurality of conduits to change an internal air pressure of the selected inflatable bladder in response to receiving the information.

### BRIEF DESCRIPTION OF THE DRAWINGS

The present invention will hereinafter be described in conjunction with the following drawing figures, wherein like numerals denote like elements, and wherein

FIG. 1 is a perspective view of a non-limiting example of a vehicle suitable for use with the adjustable seat disclosed herein;

FIG. 2 is a block diagram illustrating the adjustable seat of FIG. 2;

FIG. 3 is a flow chart illustrating a non-limiting example of a process for implementing adjustment of the adjustable seat of FIG. 2;

FIG. 4 is a perspective, schematic, torn-away view of the adjustable seat of FIG. 2;

FIG. 5 is a perspective, schematic view illustrating standard inflation of seat bottom side bolsters of the adjustable seat of FIG. 2;

FIG. 6 is a perspective, schematic view illustrating standard inflation of seat back lumbar bolsters of the adjustable seat of FIG. 2;

FIG. 7 is a perspective, schematic view illustrating standard inflation of seat back side bolsters of the adjustable seat of FIG. 2;

FIG. 8 is a perspective, schematic view illustrating an example of smart inflation of the adjustable seat of FIG. 2;

FIG. 9 is a schematic, side, torn-away view of the vehicle seat of FIG. 2 illustrating an arrangement of internal components;

FIG. 10 is a fragmentary, schematic view illustrating a portion of a duct, a valve, and a pressure sensor used to facilitate adjustment of the adjustable seat of FIG. 2 with the valve in a closed position;

FIG. 11 is a fragmentary, schematic view illustrating the portion a duct, the valve, and the pressure sensor of FIG. 11 with the valve in an opened position;

FIG. 12 is a perspective view illustrating a non-limiting embodiment of an inflatable bladder suitable for use with the adjustable seat of FIG. 2;

FIG. 13 is a side view illustrating the inflatable bladder of FIG. 13 in an uninflated state; and

FIG. 14 is a side view illustrating the inflatable bladder of FIG. 13 in a fully inflated state.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

An improved adjustable seat is disclosed herein. The adjustable seat of the present disclosure employs inflatable (and deflatable) bladders having a rectangular configuration (i.e., a cross-section taken in a lateral direction through the inflatable bladder at an angle perpendicular to the longitudinal axis of the inflatable bladder is rectangular, wherein the primary direction of expansion and contraction during inflation and deflation, respectively constitutes the longitudinal axis of the inflatable bladder). In some embodiments, the rectangular configuration may comprise a squarish configuration. In an embodiment, a plurality of rectangular inflatable bladders as disclosed and described in pending U.S. patent application Ser. No. 17/658,736 filed on 11 Apr. 2022 may be employed. U.S. patent application Ser. No. 17/658,736 is hereby incorporated herein by reference in its entirety. A rectangular configuration provides the advantage of permitting each inflatable bladder of the plurality of inflatable bladders to be positioned adjacent one another along their respective linear sides, thereby permitting a closer adjacent positioning and a denser packing arrangement of the inflatable bladders. This denser arrangement of the inflatable bladders permits a larger number of bladders to be assembled within a predetermined area, such as a seat back or a seat bottom, as compared with conventional inflatable bladders having a circular configuration. This denser packing of inflatable bladders, in turn, permits a greater amount of support to be provided to a seat occupant as well as a greater ability to tailor such support to accommodate the specific needs of each seat occupant.

A plurality of subsets of inflatable bladders are linked together by a corresponding plurality of air ducts. The air ducts permit the contemporaneous inflation and deflation of each of the inflatable bladders in the corresponding subset. Each subset of inflatable bladders linked together by a single duct shall be referred to herein as a “cell” or as a “cell of inflatable bladders”. By arranging the different cells of inflatable bladders in an organized manner within either the seat bottom or the seat back (or both) of the adjustable seat, specific anatomical regions of a seat occupant's body can be targeted for increased or decreased levels of support.

In addition, the adjustable seat of the present disclosure either includes or has access to a controller, a source of pressurized air, and a sensor or a plurality of sensors. The sensor or plurality of sensors is configured to detect the occurrence of a weight shift by a seat occupant. The controller is configured to communicate with the plurality of sensors and to change the internal air pressure of an inflatable bladder or of one or more cells of inflatable bladders by inflating and/or deflating specific inflatable bladders and/or cells of inflatable bladders based on the detected weight shift to provide added support and/or diminished support to the specific locations on the body of the seat occupant.

In an embodiment, because the inflatable bladders have a rectangular configuration with corrugated or accordion-like folds in its vertical sides, when the inflatable bladders are inflated and deflated, their lateral dimensions do not change substantially but their longitudinal dimensions do change substantially. Because of the magnitude of the longitudinal extension of each rectangular inflatable bladder, these inflatable bladders are well suited to perform a massage function. With this in mind, the controller is configured to inflate and deflate the cells of inflatable bladders in a rhythmic manner for the purposes of providing a massage function to deliver added comfort and stress relief to the seat occupant as well as improving the blood flow/circulation of a seat occupant.

A greater understanding of the adjustable seat discussed above may be obtained through a review of the illustrations accompanying this application together with a review of the detailed description that follows.

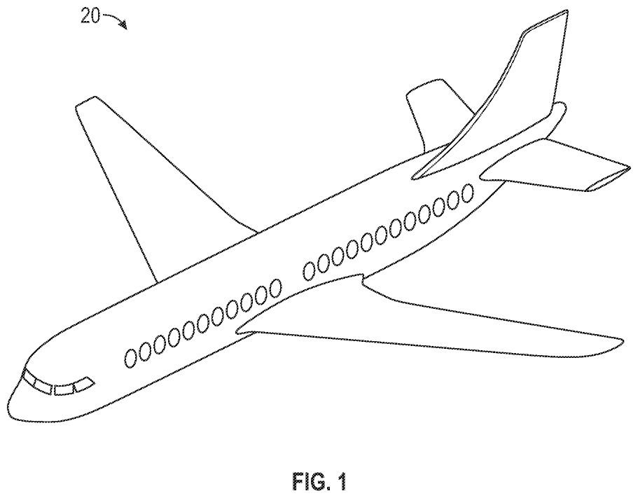

FIG. 1 is a perspective view of a non-limiting example of a vehicle 20 suitable for use with the adjustable seat disclosed herein. In the illustrated embodiment, vehicle 20 is depicted as aircraft. While the adjustable seat disclosed herein is compatible for use onboard an aircraft, it should be understood that the adjustable seat disclosed here is not limited to such use. Rather, the seat disclosed herein is compatible with all types of vehicles including, but not limited to, automobiles, busses, recreational vehicles, trains, boats, spacecraft, and the like and may be employed in any other such vehicle without departing from the teachings of the present disclosure. Further, the adjustable seat disclosed herein is not limited to with vehicles. Rather, the adjustable seat disclosed herein may be used in any conceivable seating application. For instance, and without limitation, the adjustable seat disclosed herein may be employed in domestic furniture applications, office furniture applications, manufacturing furniture applications, theater seating applications, stadium seat applications, and the like without departing from the teachings of the present disclosure.

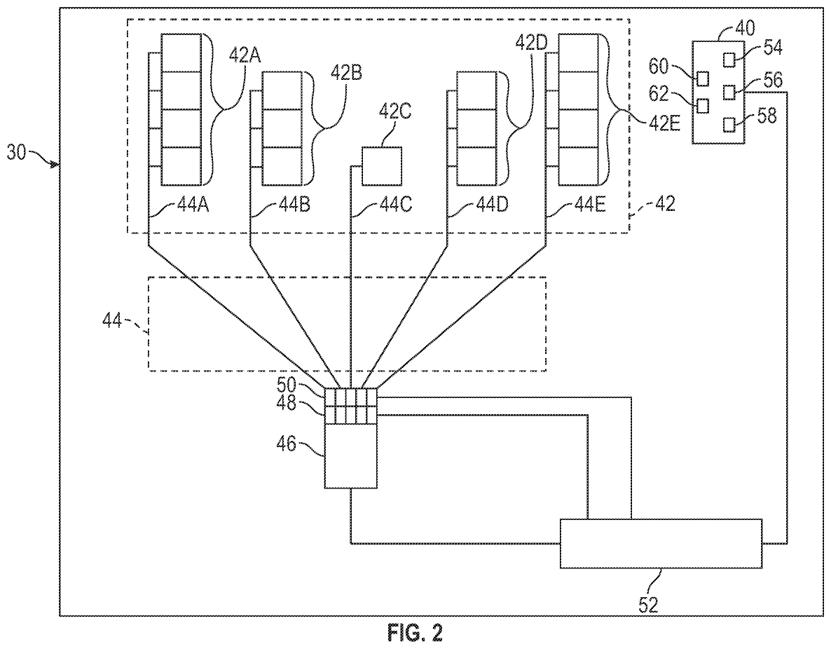

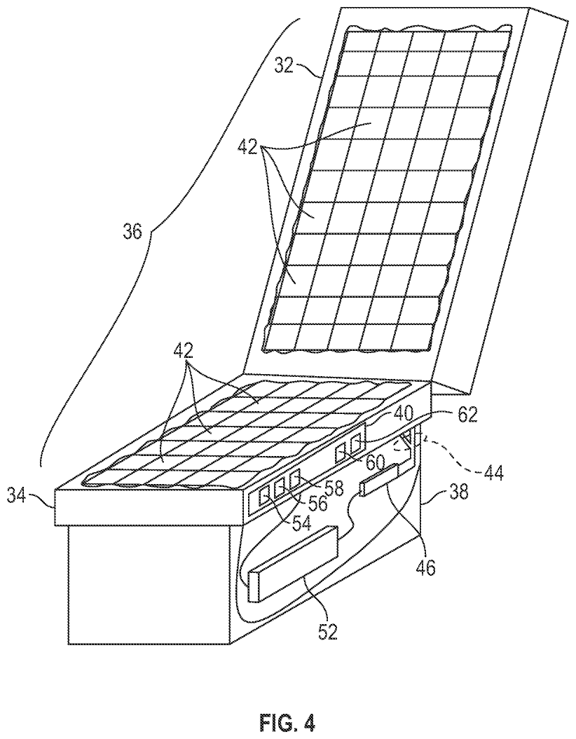

With continuing reference to FIG. 1, FIG. 2 is a block diagram illustrating a non-limiting embodiment of an adjustable seat 30 made in accordance with the teachings of the present disclosure. Adjustable seat 30 includes a seat back 32 (see FIG. 4) a seat bottom 34 (see FIG. 4) (together, seat back 32 and seat bottom 34 comprise seat body 36 (see FIG. 4)), a seat body support 38 (see FIG. 4), a user input device 40, a plurality of inflatable bladders 42, a plurality of conduits 44, a pump 46, a plurality of valves 48, a plurality of pressure sensors 50, and a controller 52.

Plurality of inflatable bladders 42 are arranged in cells. In the illustrated embodiment, five such cells are illustrated, but it should be understood that any suitable number of cells may be employed without departing from the teachings of the present disclosure. Each cell comprises a subset of one or more inflatable bladders that have been fluidly coupled together by a single conduit of plurality of conduits 44. In the embodiment illustrated in FIG. 2, there are five cells of inflatable bladders including cell 42A, 42B, 42C, 42D, and 42E. In the illustrated embodiment, cell 42A includes four individual inflatable bladders, cell 42B includes three individual inflatable bladders, cell 42C includes one individual inflatable bladder, cell 42D includes three individual inflatable bladders, and cell 42E includes four individual inflatable bladders. The individual inflatable bladders of cell 42A are fluidly coupled together by conduit 44A. The individual inflatable bladders of cell 42B are fluidly coupled together by conduit 44B. The individual inflatable bladder of cell 42C is fluidly coupled to conduit 44C. The individual inflatable bladders of cell 42D are fluidly coupled together by conduit 44D. And the individual inflatable bladders of cell 42E are fluidly coupled together by conduit 44E. While the embodiment illustrated in FIG. 2 illustrates a total of five cells, it should be understood that in other embodiments a greater or lesser number of cells may be employed. Further, in such other embodiments, each cell may have a greater or lesser number of individual inflatable bladders. In this way, plurality of inflatable bladders 42 and the support that each individual inflatable bladder provides may be tailored to each unique seating application.

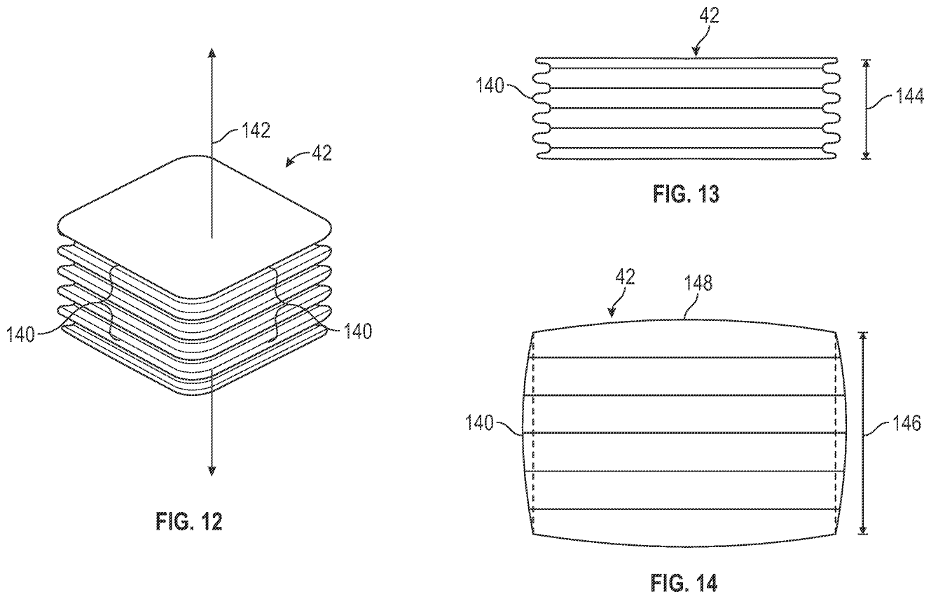

Each individual inflatable bladder of plurality of inflatable bladders 42 has a rectangular configuration when viewed from above. In some embodiments, some or all of the individual inflatable bladders of plurality of inflatable bladders 42 may have a square or squarish configuration when viewed from above. This configuration permits the individual inflatable bladders to be densely packed together in seat body 36 as compared with conventional seat bladder arrangements. As illustrated in FIGS. 12-14, each individual bladder has a folded ribbed or accordion-like configuration around its lateral periphery that permits the inflatable bladder to expand primarily, if not entirely, along its longitudinal axis as it is inflated. In other words, as each inflatable bladder is inflated, its height increases, but its width does not or, if it does, it does not increase substantially. This further facilitates the ability to densely pack together the individual bladders in seat body 36. In other embodiments, any other alternate configuration that is effective to promote expansion of the inflatable bladder along a single axis may be employed without departing from the teachings of the present disclosure.

Each inflatable bladder of plurality of inflatable bladders 42 may be comprised of any suitable material that is effective to contain a fluid and/or to contain a pressurized fluid. In some embodiments, each inflatable bladder of plurality of inflatable bladders 42 may be comprised of fiberglass reinforced vulcanized rubber or silicone. In other embodiments, plastic and other composite materials may also comprise suitable materials. In other embodiments, any suitable material having no capacity or only a relatively minor capacity to stretch may be employed.

In the embodiment disclosed herein, each individual conduit of plurality of conduits 44 comprises a tube-like or cylindrical structure suitable for conveying a fluid such as compressed air between the source of the compressed air and the cells of inflatable bladders. Each conduit of plurality of conduits 44 may be comprised of any suitable material that is effective to contain a fluid and/or a pressurized fluid and to convey that fluid from one location to another. In some embodiments, each conduit of plurality of conduits 44 may be comprised of fiberglass reinforced vulcanized rubber or silicone. In other embodiments, plastic and other composite materials may also comprise suitable materials.

Pump 46 may comprise any suitable pump that is effective to compress air (or any other suitable fluid) and to deliver compressed air to plurality of conduits 44. Pump 46 is fluidly coupled with plurality of conduits 44 and is configured to deliver compressed air to each conduit of plurality of conduits 44. In other embodiments of adjustable seat 30, rather than using a pump, any other suitable source of compressed air may be employed.

Plurality of valves 48 may comprise any suitable valve that is effective to control the passage of air into and out of plurality of conduits 44. In the illustrated embodiment, each valve of plurality of valves 48 is fluidly coupled with a corresponding conduit of plurality of conduits 44 and is configured to control the movement of air (such as compressed air) into and/or out of said corresponding conduit. Each valve of plurality of valves 48 is configured to move between an open position and a closed position. When a valve of plurality of valves 48 is in the open position, air may move into or out of the corresponding conduit. When a valve is in the closed position, air is inhibited from moving into or out of the corresponding conduit.

Each pressure sensor of plurality of pressure sensors 50 may comprise any suitable sensor that is effective to detect the pressure of the air within each conduit of plurality of conduits 44. Each pressure sensor of plurality of pressure sensors 50 is fluidly coupled with a respective conduit of plurality of conduits 44. This respective coupling permits the measurement of air pressure within each conduit and, by extension, the measurement of air pressure within each cell of inflatable bladders. In some embodiments, plurality of pressure sensors 50 may be coupled with, or may be a component of a respective valve of plurality of valves 48. In other embodiments, plurality of pressure sensors 50 may be fluidly coupled with controller 52 or with plurality of conduits 44. In still other embodiments, each inflatable bladder of each cell may have an associated pressure sensor. In other embodiments, rather than comprising air pressure sensors, the pressure sensor may comprise a grid of sensors arrayed along any suitable surface of adjustable seat 30. Any other type or arrangement of pressure sensors suitable for assessing the pressure within each cell of inflatable bladders or suitable for detecting the distribution of a seat occupant's weight along support surfaces of adjustable seat 30 may alternatively be employed without departing from the teachings of the present disclosure.

Plurality of pressure sensors 50 are configured to detect air pressure within a conduit and/or within a cell of inflatable bladders. The air pressure within each conduit or within each cell of inflatable bladders corresponds with the weight compressing each cell. As an occupant of adjustable seat 30 shifts his or her weight from one side of adjustable seat 30 to another, the side where the weight has been shifted to will experience an increase in internal air pressure and the side where the weight has been shifted from will experience a reduction in internal air pressure. As explained in detail below, controller 52 is configured to receive information from plurality of pressure sensors 50 indicative of the current air pressure within each cell and, based on this information, to determine whether weight has been shifted and how quickly weight has been shifted, and to then use and this shift and this rate of shift to determine whether and how to respond. Although the illustrated embodiment employs pressure sensors to detect the shifting of weight by a seat occupant who is seated in adjustable seat 30, it should be understood that any other device or mechanism that is effective to detect the movement of a seat occupant within the seat and/or the redistribution of the seat occupant's weight along seat back 32 and/or along seat bottom 34 and/or along any other surface of adjustable seat 30 may alternatively be employed without departing from the teachings of the present disclosure.

User input device 40 may comprise any component suitable to receive inputs from the occupant of adjustable seat 30. For example, and without limitation, user input device 40 may be a smart phone, a mobile device, a keyboard, a mouse, a touch screen, a tablet and stylus, a button, a switch, a knob, a slide, a microphone, a camera, a motion detector, or any other device that is configured to permit a human to provide inputs into an electronic system. In some embodiments, user input device 40 may be dedicated for use exclusively with adjustable seat 30 while in other embodiments user input device 40 may be shared with other systems on board vehicle 20. As discussed in greater detail below, in the embodiment illustrated in the present disclosure, user input device 40 comprises a plurality of depressible buttons mounted to seat bottom 34.

Controller 52 may be any type of onboard computer, controller, micro-controller, circuitry, chipset, computer system, or microprocessor that is configured to perform algorithms, to execute software applications, to execute sub-routines and/or to be loaded with and to execute any other type of computer program. Controller 52 may comprise a single processor or a plurality of processors acting in concert. In some embodiments, Controller 52 may be dedicated for use exclusively with adjustable seat 30 while in other embodiments controller 52 may be shared with other systems of vehicle 20.

Controller 52 is communicatively coupled with user input device 40 and plurality of pressure sensors 50 and is operatively coupled with pump 46 and plurality of valves 48. Such couplings may be accomplished through the use of any suitable means of transmission including both wired and wireless connections. For example, each component may be physically connected to controller 52 via a coaxial cable or via any other type of wire connection effective to convey signals. In the illustrated embodiment, controller 52 is directly communicatively coupled to each of the other components. In other embodiments, each component may be communicatively and/or operatively coupled to controller 52 across a bus. In still other examples, each component may be wirelessly coupled with controller 52 via a Bluetooth connection, a WiFi connection or the like.

Being communicatively and/or operatively coupled provides a pathway for the transmission of commands, instructions, interrogations and other signals between controller 52 and each of the other components. Through this communicative connection, controller 52 may control and/or communicate with each of the other components and each of the components discussed above may be configured to interface and engage with controller 52. For example, in some embodiments, plurality of valves 48 may be configured to receive commands from controller 52 and to open and remain open or to close and to remain closed in response to such commands. In some embodiments, each pressure sensor of plurality of pressure sensors 50 may be configured to automatically provide to controller 52 information indicative of the pressure within each respective conduit of plurality of conduits 44 at regular intervals. In other embodiments, each pressure sensor of plurality of pressure sensors may be configured to provide such pressure related information to controller 52 in response to an interrogation received from controller 52. In some embodiments, pump 46 may be configured to receive instructions from controller 52 and to initiate pumping air or to discontinue pumping air in response to such instructions. In some embodiments, user input device 40 may be configured to convert operator actions and/or movements into electronic signals and to communicate such signals to controller 52.

Controller 52 is configured to interact with, coordinate and/or orchestrate the activities of each of the other components of adjustable seat 30 described above for the purpose of (1) providing a seat-occupant-directed level of cushioning support, (2) providing a seat occupant with smart cushioning support, and (3) providing a seat occupant with a massage. To accomplish these objectives, controller 52 may be programmed and/or otherwise configured to respond to various inputs and signals as described below.

To provide a seat occupant with an occupant directed level of cushioning, controller 52 is configured to receive an instruction from user input device 40 and to then control pump 46 and plurality of valves 48 in a manner that corresponds with that instruction. For example, if an occupant of adjustable seat 30 depresses a button that sends a signal corresponding with inflation of plurality of inflatable bladders 42, then in response to receiving that signal, controller 52 is configured to control plurality of valves 48 to move to an open configuration and to contemporaneously control pump 52 to begin pumping compressed air into plurality of conduits 44. This will continue until the occupant of adjustable seat 30 discontinues depression of the button corresponding with such inflation, whereupon controller 52 will control plurality of valves 48 to move to a closed configuration and to contemporaneously control pump 52 to discontinue pumping compressed air into plurality of conduits 44.

In an embodiment, user input device 40 may include multiple buttons. Some of the buttons may correspond with a different anatomical feature of the seat occupant. For example, user input device 40 may include a button 54 corresponding with a seat occupant's thighs, a button 56 corresponding with a seat occupant's lower back, and a button 58 corresponding with upper and outer portions of seat occupant's rib cage. Further, user input device 40 may include a button 60 and a button 62. Button 60 may correspond with a comfort mode in which adjustable seat 30 performs a “smart” or “intuitive” inflation protocol and button 62 may correspond with a massage function. In other embodiments, additional buttons may be provided to control inflation of regions of seat body 36 corresponding with other anatomical features of the seat occupant and/or to provide additional functionality such as, but not limited to, heating and ventilation.

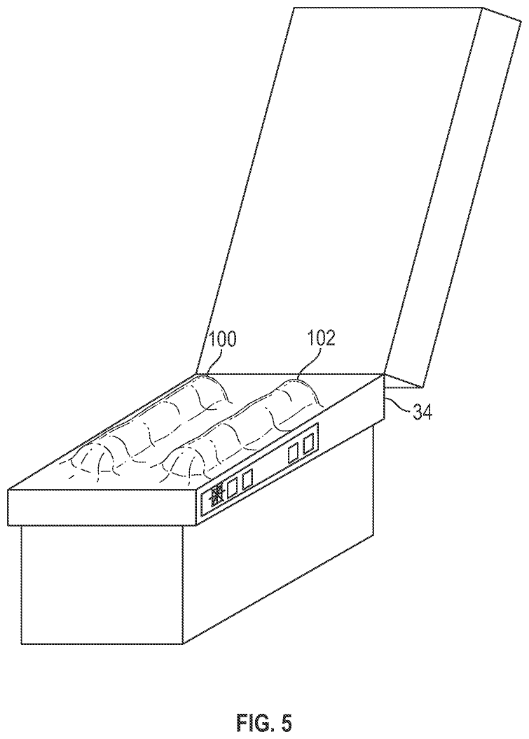

In the above example, when a seat occupant depresses button 54, user input device 40 will convey an instruction to controller 52 indicative of the seat occupant's request to receive an increase in cushioning support under or adjacent to the seat occupant's thighs. In response to receiving this instruction, controller 52 is configured to open a subset of valves corresponding with designated cells that are located in a portion of seat bottom 34 that corresponds with the location where a seat occupant's thighs are likely to be supported. Controller 52 will contemporaneously actuate pump 46 to pump compressed air through those open valves and into their respective conduits leading to the inflatable bladders of the designated cells. For example, if cell 42A and cell 42E correspond with a portion of seat bottom 34 that aligns with the seat occupant's thighs, then actuation of button 54 will cause compressed air to flow into cell 42A and 42E. This will result in the inflation of seat bottom thigh bolsters as best illustrated in FIG. 5.

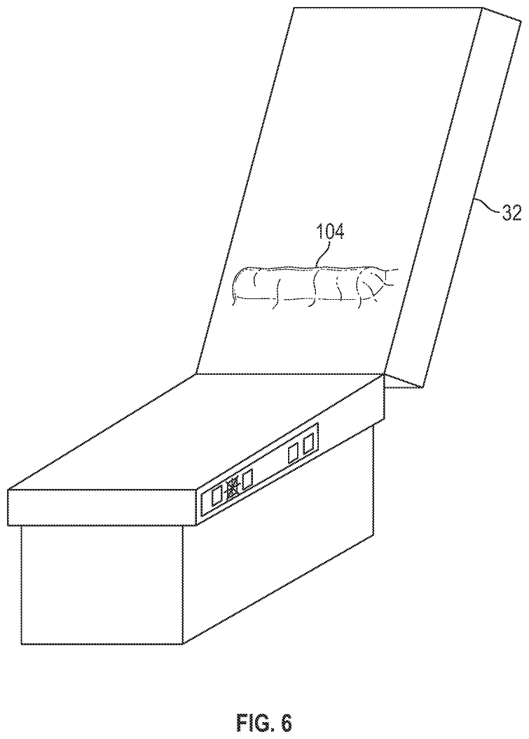

Similarly, when a seat occupant depresses button 56, user input device 40 will convey an instruction to controller 52 indicative of the seat occupant's request to receive an increase in cushioning support adjacent to the seat occupant's lower back. In response to receiving this instruction, controller 52 is configured to open a different subset of valves corresponding with designated cells located in a portion of seat back 32 corresponding with the seat occupant's lower back. Controller 52 will contemporaneously actuate pump 46 to pump compressed air through those open valves and into their respective conduits leading to the inflatable bladders of the designated cells. For example, if cell 42C corresponds with a portion of seat back 32 that aligns with the seat occupant's lower back, then actuation of button 56 will cause compressed air to flow into cell 42C. This will result in the inflation of a seat back lumbar support as best illustrated in FIG. 6.

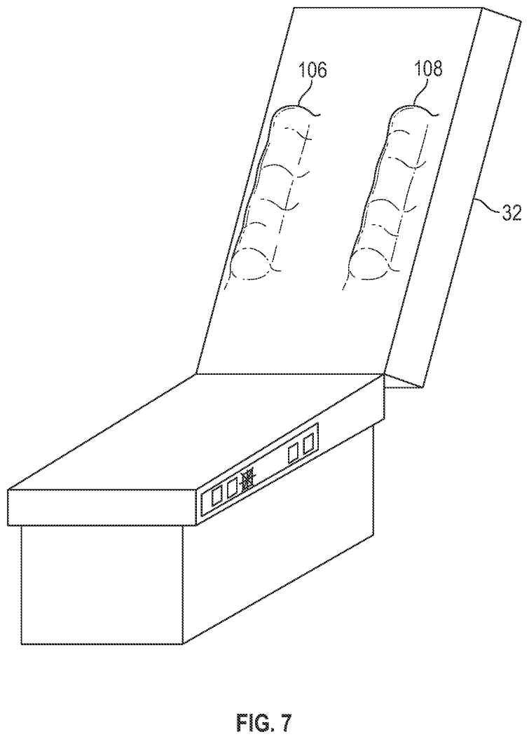

Similarly, when a seat occupant depresses button 58, user input device 40 will convey an instruction to controller 52 indicative of the seat occupant's request to receive an increase in cushioning support adjacent to the upper and outer portions of the seat occupant's rib cage. In response to receiving this instruction, controller 52 is configured to open yet another subset of valves corresponding with designated cells located in a portion of seat back 32 corresponding with upper and outer portions of the seat occupant's rib cage. Controller 52 will contemporaneously actuate pump 46 to pump compressed air through those open valves and into their respective conduits leading to the inflatable bladders of the designated cells. For example, if cell 42B and cell 42D correspond with a portion of seat back 32 that aligns with upper and outer portions of the seat occupant's rib cage, then actuation of button 58 will cause compressed air to flow into cell 42B and 42D. This will result in the inflation of seat back rib bolsters as best illustrated in FIG. 7.

When lesser amount of thigh support, lumbar support, and/or rib cage support is desired, each corresponding button may be actuated in a second manner corresponding with deflation. Upon receiving an instruction to deflate, controller 52 is configured to open the valves of the corresponding cells to permit the compressed air to vent to the ambient environment outside of plurality of conduits 44. Such deflation will continue until either each inflatable bladder of the corresponding cell of inflatable bladders has been fully deflated or until the seat occupant releases the respective button, thereby ceasing transmission of the instruction to deflate.

In an embodiment, when a seat occupant depresses button 60, the seat occupant is actuating a smart or intuitive comfort feature whereby adjustable seat 30 is configured to detect where and when a seat occupant is experiencing discomfort and to address such discomfort without awaiting further input from the seat occupant. When the user actuates this feature, controller 52 will monitor plurality of pressure sensors 50. When pressure sensors 50 sense a pressure change, information indicative of that pressure change is communicated to controller 52. Controller 52 is configured to determine which pressure sensor(s) of plurality of pressure sensors 50 sensed the pressure change based on the information provided by plurality of pressure sensors 50. This, in turn, permits controller 52 to determine which cell or cells of inflatable bladders correspond with the portion or portions of the seat occupant's body where the weight was shifted from and where the weight was shifted to.

Controller 52 is further configured to calculate the magnitude of the pressure change based on the information provided by plurality of pressure sensors 50. The magnitude of the pressure change corresponds with the amount of weight that the seat occupant has shifted. Controller 52 is further configured to calculate the amount of time over which the pressure change occurred based on the information provided by plurality of pressure sensors 50.

Controller 52 is further configured to compare the magnitude of the pressure change with a predetermined pressure-change-threshold and to compare the amount of time of the pressure change with a predetermined time-threshold. If the magnitude of the pressure change falls below the predetermined pressure-change-threshold or if the amount of time over which the pressure change transpired exceeds the time-threshold, then controller 52 is configured to take no action. This is because, in examples where adjustable seat 30 is installed onboard vehicle 20 (or onboard any other vehicle), modest pressure changes or slow pressure changes can be attributable to vehicle dynamics rather than seat occupant repositioning.

However, if the magnitude of the pressure change exceeds the predetermined pressure-change-threshold and if the amount of time over which the pressure change transpires falls below the predetermined time-threshold, then the controller is configured to take action to enhance the comfort of the seat occupant. In such an event, controller 52 is configured to identify the cell or cells onto which and/or off of which the seat occupant has shifted his or her weight based on the information received from plurality of sensors 50. Such cells are referred to herein as “selected cells” (in embodiments where plurality of inflatable bladders 42 is not divided into cells, the inflatable bladder or bladders corresponding with the anatomical feature of the seat occupant onto which and/or off of which the seat occupant has shifted his or her weight are referred to as a “selected inflatable bladder” or as “selected inflatable bladders”, respectively. For example, if cell 42A is disposed on the left side of seat bottom 34 and if cell 42E is disposed on the right side of seat bottom 34, and if the seat occupant quickly shifted his or her weight from the right side of seat bottom 34 to the left side of seat bottom 34, then controller 52 would identify cell 42A and cell 42E as the selected cells.

Controller 52 is further configured to control pump 46 and plurality of valves 48 to add and/or remove a predetermined amount of air in the selected cell or cells to change their internal air pressure. In the example above, controller 52 would be control pump 46 and plurality of valves 48 to remove air from cell 42A to soften the portion of the seat onto which the seat occupant's weight has been shifted, and to add compressed air into cell 42E to firm up the portion of the seat from which the seat occupant's weight has been shifted from. In this manner, a relatively uniform internal air pressure can be attained/maintained across all cells and across all inflatable bladders. In embodiments where plurality of inflatable bladders 42 are not divided into cells, controller 52 would control pump 46 and plurality of valves 48 to add compressed air into and/or to remove air from the selected inflatable bladder or bladders in an effort to increase seat occupant comfort through the maintenance of a substantially uniform internal air pressure across all inflatable bladders 42.

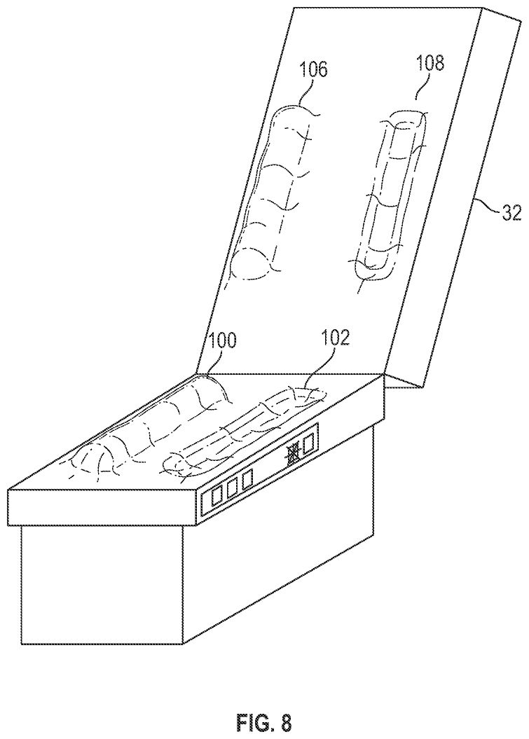

In some embodiments, controller 52 may be further configured to control plurality of valves 48 to permit deflation of the selected cell or selected cells (see FIGS. 8). In this manner, controller 52 can accommodate the anatomical features of the seat occupant which are now bearing more weight by ensuring that such anatomical features are exposed to a softened or reduced amount of support from adjustable seat 30. Through the inflation of some inflatable air bladders/cells and the deflation of others, the air pressure in the inflated/deflated cells are equalized to enhance the comfort of the seat occupant.

Once button 60 has been pressed and the smart or intuitive comfort feature of adjustable seat 30 has been actuated, controller 52 is configured to continue monitoring plurality of pressure sensors 50 until it receives a cancellation instruction from user input device 40. In an embodiment, when an instruction from a seat occupant to inflate designated cells or designated inflatable bladders is in conflict with a determination by controller 52 to inflate selected cells or selected inflatable bladders, controller 52 is configured to comply with the instruction to inflate the designated cells or the designated bladders. In an embodiment, if the smart or intuitive comfort feature has been actuated and controller 52 is monitoring plurality of pressure sensors 50, then receipt by controller 52 of an instruction to inflate a designated cell(s) or to inflate a designated inflatable bladder(s) will cause controller 52 to discontinue operation in the smart or intuitive comfort mode.

When a seat occupant depresses button 62, the seat occupant is actuating a massage feature. When controller 52 receives an instruction from user input device 40 to initiate the massage feature, controller 52 is configured to alternately fully inflate and to fully deflate each cell (or each inflatable bladder in embodiments of adjustable seat 30 where plurality of inflatable cells 42 are not divided into cells) in a predetermined pattern. The predetermined pattern of inflation and deflation may have a rhythmic sequence, a random sequence, or any other suitable sequence of inflation or deflation that provides comfort to a seat occupant.

Because each inflatable bladder of plurality of inflatable bladders 42 has a rectangular configuration and extends almost exclusively along its longitudinal axis, each inflatable bladder of plurality of inflatable bladders 42 extends a greater distance than a conventional (i.e., circular) inflatable bladder which makes plurality of inflatable bladders well suited to support the massage function. In addition, each inflatable bladder's rectangular or squarish configuration may cause the upper surface of the inflatable bladder to bulge outwardly, yielding a dome-like protrusion as the inflatable bladder reaches a state of full inflation. This dome-like protrusion further extends the height of each inflatable bladder and focuses the contact area between the bladder and the body of the seat occupant, allowing for a concentrated application of force exerted by each inflatable bladder onto the body of the seat occupant. This concentration further enhances the comfort imparted by the massage feature of adjustable seat 30.

In the illustrated embodiment, controller 52, pump 46, plurality of valves 48, plurality of pressure sensors 50 and user input device 40 have been illustrated as distinct components and, in some cases, as separate components. It should be understood that in other embodiments, any or all of these components may be integrated into a single component that provides all of the above-described functionality without departing from the teachings of the present disclosure.

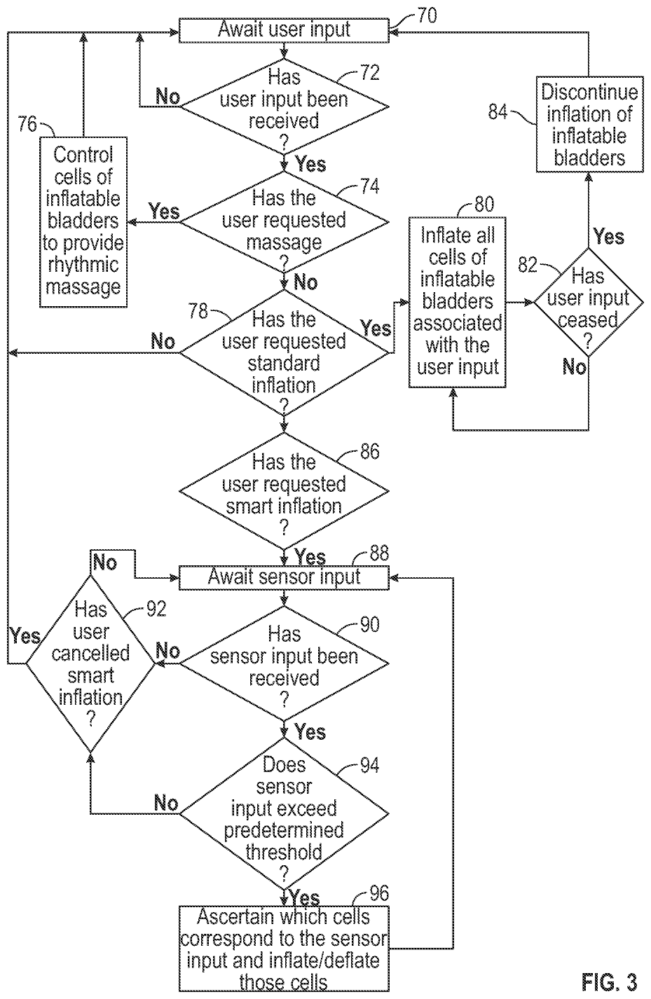

With continuing reference to FIGS. 1-2, FIG. 3 is a flow chart illustrating a non-limiting example of a process for implementing the various features of adjustable seat 30. At step 70, adjustable seat 30 has been switched on and controller 52 awaits a user input. At step 72, controller 52 assesses whether it has received a user input. If not, the process returns to step 70. If controller 52 has received a user input, then the process continues to step 74. At step 74, the controller ascertains whether the user input comprises a massage request. If the answer is yes, then the process progresses to step 76. At step 76, controller 52 is configured to implement a predetermined and repeating pattern of inflation and deflation of cells and/or plurality of inflatable bladders 42. In some embodiments, the massage function may remain actuated for a predetermined period of time while in other embodiments, controller 52 may be configured to continue implementation of the massage function until a second user input is received instructing that the massage function be terminated. At that time, the process returns to step 70. If at step 74 it is determined that the user input is not a massage request, then the process continues to step 78.

At step 78, controller 52 is configured to ascertain whether the user input comprises a request for a standard comfort inflation. If the answer to that question is yes, then the process continues to step 80. At step 80, controller 52 is configured to inflate all designated inflatable bladders or all designated cells of inflatable bladders. Accordingly, if the input is received from button 54, then controller 52 will inflate all of the inflatable bladders of cell 42A and of cell 42E. If the input is received from button 56, then controller 52 will inflate all of the inflatable bladders of cell 42C. If the input is received from button 58, then controller 52 will inflate the inflatable bladder of cell 42B and of inflatable bladder 42D. Once inflation of the designated inflatable bladders or designated cells has begun, such inflation will continue until the user input requesting such inflation ceases. Accordingly, the process continues to step 82 where processor 52 is configured to ascertain whether the user input requesting inflation is still being received or whether it has ceased. If the user input is still being received, then the process returns to step 80 where inflation of the designated inflatable bladders and/or cells continues. If the user input has ceased, then the process progresses to step 84 where inflation of the designated inflatable bladders and/or designated cells discontinues. From there, the process returns to step 70 and controller 52 awaits further user inputs. If, at step 78, it is determined that the user input is not a request for standard inflation, then the process progresses to step 86.

At step 86, controller 52 is configured to ascertain whether the user input is a request for smart comfort inflation. If the answer is yes, then the process progresses to step 88. At step 88, controller 52 is configured to enter a smart inflation mode where it begins to monitor for inputs from plurality of pressure sensors 50. In embodiments where some other type of sensor is implemented to detect changes/shifts in the weight distribution of a seat occupant, controller 52 would be configured to communicate with such other sensor and monitor such other sensor for inputs. The process then progresses to step 88 where controller 52 remains in a continuous monitoring state wherein it awaits inputs from plurality of pressure sensors 50. At step 90 controller 52 determines whether it has received a sensor input. If it has not received a sensor input, the process progresses to step 92 wherein controller 52 ascertains whether it has received a cancellation request from user input device 40. If controller 52 has received a cancellation request, then the process returns to step 70 wherein controller 52 awaits the next user input. If controller 52 has not received a cancellation request, then the process returns to step 88 wherein controller 52 awaits the next sensor input.

If, at step 90, controller 52 did receive a sensor input, the process progresses to step 94. At step 94, controller 52 ascertains whether the sensor input exceeds predetermined thresholds. For example, controller 52 may ascertain whether the magnitude of the weight shift exceeds the predetermined-pressure-change threshold of, in some embodiments, 0.5 psi, in other embodiments, 0.75 psi, and in still other embodiments, any pressure shift in the range of 0.5 psi to 0.75 psi and/or whether the weight shift happened within the predetermined time threshold, which, in some embodiments, may be five seconds, in other embodiments, ten seconds, and in still other embodiments, any time span between five seconds and ten seconds. If the sensor input does not exceed the predetermined thresholds, then the process returns to step 92.

If the sensor input does exceed the predetermined thresholds, then the process progresses to step 96. At step 96, controller 52 is configured to identify selected inflatable bladders or selected cells and to inflate and/or deflate such selected inflatable bladders or selected cells by introducing a predetermined amount of compressed air and/or by releasing a predetermined amount of air contained within the selected inflatable bladders/selected cells. In some embodiments, controller 52 may also be configured to identify the inflatable bladders and/or cells of inflatable bladders proximate the portion of the seat occupant's body where the seat occupant's weight was shifted from and to open valves of plurality of valves 48 associated with those inflatable bladders and/or cells of inflatable bladders to deflate them by a predetermined amount. In some instances, the change in pressure may be as little as 0.2 psi while in other instances, the change in pressure may be as much as 1.75 psi. After performing this targeted inflation of selected inflatable bladders and/or cells of inflatable bladders, the process returns to step 88.

With continuing reference to FIGS. 1-3, FIG. 4 is a perspective, schematic, torn-away view of adjustable seat 30. With the surface of seat back 32 and seat bottom 34 partially torn away, plurality of inflatable bladders 42 are visible. As illustrated, each inflatable bladder of plurality of inflatable bladders 42 has a rectangular configuration and, as a result, the inflatable bladders may be densely packed together with little or no space between them. As further illustrated in FIG. 4, seat body 36 is supported by seat body support 38. In the illustrated embodiment, seat body support 38 comprises a pedestal. In other embodiments, seat body support 38 may comprise any suitable structure(s) that is effective to support seat body 36 in an elevated position above a floor surface. In the illustrated embodiment, user input device 54 is disposed on a side portion of seat bottom 34. In other embodiments, user input device 40 may be mounted to any other suitable portion of seat body 36 and/or seat body support 38. In still other embodiments, user input device may comprise a mobile device such as a tablet or mobile phone configured with an application that a seat occupant can use to communicate with controller 52, either directly or indirectly through a communication receiver.

A portion of seat body support 38 has been torn away to reveal controller 52, pump 46 and plurality of conduits 44. In the illustrated embodiment, plurality of valves 48 and plurality of pressure sensors 50 are housed within the housing for pump 46 and, for this reason, are not separately illustrated. In other embodiments, these components may be housed outside of seat body support 38 in a stand-alone unit and mounted to seat body support 38 or to any suitable portion of seat body 36 without departing from the teachings of the present disclosure.

With continuing reference to FIGS. 1-4, FIG. 5 is a perspective, schematic view illustrating inflation of a pair of seat bottom side bolsters (seat bottom side bolster 100 and seat bottom side bolster 102) associated with seat bottom 34. In an embodiment, seat bottom side bolsters 100 and 102 are disposed above cells 42A and 42E, respectively. As illustrated in FIG. 5, both seat bottom side bolsters 100 and 102 have been inflated, causing corresponding portions of the upper surface of seat bottom 34 to swell or protrude upwards. To achieve this protrusion, the seat occupant depressed button 54 on user input device 40. This, in turn, has caused controller 52 to control both pump 46 and plurality of valves 48 in a manner that directed compressed air into designated cells 42A and 42E.

With continuing reference to FIGS. 1-5, FIG. 6 is a perspective, schematic view illustrating inflation of a lumbar bolster 104 associated with seat back 32. In an embodiment, lumbar bolster 104 is disposed adjacent cell 42C. As illustrated in FIG. 6, lumbar bolster 104 has been inflated, causing a corresponding portion of the forward surface of seat back 32 to swell or protrude outwards. To achieve this protrusion, the seat occupant depressed button 56 on user input device 40. This, in turn, has caused controller 52 to control both pump 46 and plurality of valves 48 in a manner that directed compressed air into designated cell 42C.

With continuing reference to FIGS. 1-6, FIG. 7 is a perspective, schematic view illustrating inflation of a pair of seat back side bolsters (seat back side bolster 106 and seat back side bolster 108) associated with seat back 32. In an embodiment, seat back side bolsters 106 and 108 are disposed adjacent cells 42B and 42D, respectively. As illustrated in FIG. 5, both side back side bolsters 106 and 108 have been inflated, causing corresponding portions of the forward surface of seat back 32 to swell or protrude outwards. To achieve this protrusion, the seat occupant depressed button 58 on user input device 40. This, in turn, has caused controller 52 to control both pump 46 and plurality of valves 48 in a manner that directed compressed air into designated cells 42B and 42D.

With continuing reference to FIGS. 1-7, FIG. 8 is a perspective, schematic view illustrating an example of smart inflation of adjustable seat 30. In FIG. 8, adjustable seat 30 has had its smart comfort function actuated and a seat occupant (not illustrated) has just shifted his weight from the left side of adjustable seat 30 (as used here, the “left side of adjustable seat 30” refers to the portion of adjustable seat 30 that is closer to the left side of the page on which FIG. 8 is printed) to the right side of adjustable seat 30. Upon detecting the weight shift based on information provided by plurality of pressure sensors 50, and upon determining that the magnitude and timing of the weight shift exceeds respective thresholds, controller 52 has actuated pump 46 and has controlled plurality of valves 48 in a manner that causes compressed air to be directed into selected cell 44A and selected cell 44B resulting in inflation of seat bottom side bolster 100 and seat back side bolster 106, respectively, as illustrated. In addition, controller 52 has contemporaneously deflated cells 42E and 42D resulting in a softening of seat bottom side bolster 102 and seat back side bolster 108, illustrated as depressions in FIG. 8. In other embodiments, in response to determining that the magnitude and timing of the weight shift exceeds respective thresholds, controller 52 may be configured to inflate selected cells 44A and 44B without deflating selected cells 44D and 44E or to deflate selected cells 44D and 44E without inflating selected cells 44A and 44B. It should be further understood that in FIG. 8, the inflation and deflation of various bolsters has been drawn in an exaggerated manner for the purposes of illustration only. In an actual embodiment, there may be no visible or detectable bulge on the left side of adjustable seat 30 and there may be no visible depression on the right side of adjustable seat 30 in the location where the inflatable bladders are located.

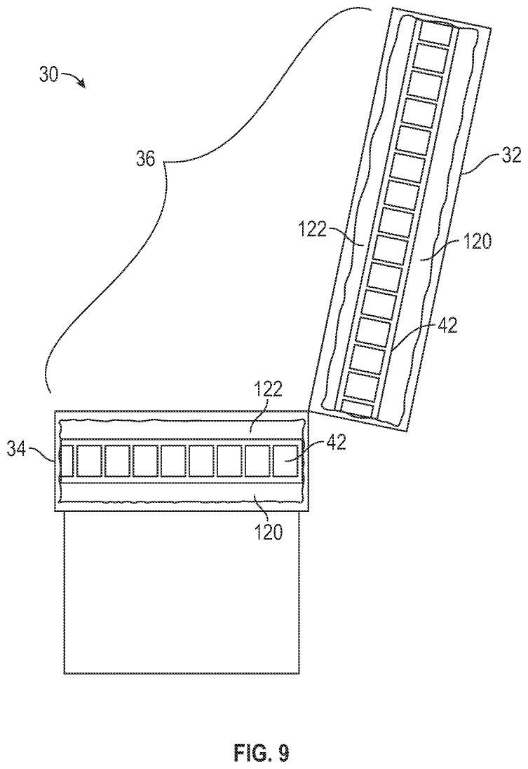

With continuing reference to FIGS. 1-8, FIG. 9 is a schematic, side, torn-away view of adjustable seat 30. With side portions of seat back 32 and seat bottom 34 torn away, an interior arrangement of some of the internal components of seat body 38 are visible. Seat back 32 and seat bottom 4 each include a support substrate 120, plurality of inflatable bladders 42, and a cushion 122. For ease of illustration and viewing, support substrate 120 has been illustrated as being spaced apart from plurality of inflatable bladders 42 which, in turn, have been illustrated as being spaced apart from cushion 122. It should be understood that in an actual embodiment of seat back 32 and seat bottom 34, these components would be pressed against one another with little or no space between them.

Conventional seating structures that are used with conventional adjustable seats have a layer of foam disposed between the inflatable bladders and the support substrate. By contrast, in adjustable seat 30, plurality of inflatable bladders 42 are disposed immediately adjacent to support substrate 120 and the only foam layer (cushion 122) is disposed above plurality of inflatable bladders 42. This provides the inflatable bladders with a firmer base against which to expand and contract.

The elimination of a second layer of foam cushioning is made possible, to a large extent, by the use of inflatable bladders having a rectangular configuration. Whereas conventional, circular inflatable bladders are completely flat when deflated, the rectangular bladders employed in adjustable seat 30 have a three-dimensional configuration that is resistant to compression even when fully deflated. When the term “fully deflated” is used herein to describe a deflated state of the rectangular inflatable bladders of plurality of inflatable bladders 42, it should be understood to mean the state of deflation that the inflatable bladder achieves when its respective valve is opened and the inflatable bladder is permitted to deflate of its own accord (i.e., without the application of any compressive force exerted by a seat occupant) to the condition where the static pressure inside the inflatable bladder is equal to the ambient atmospheric pressure surrounding the exterior of the inflatable bladder. At that point, the inflatable bladder of the present disclosure still has a substantial height component as compared with conventional bladders which are nearly completely flat. This substantial height shall be referred to herein as the “nominal height” of the inflatable bladder. Once the inflatable bladder has been vented to ambient pressure, the respective valve is closed and the air remaining therein is inhibited from escaping. In this state (i.e., in a fully deflated state), the inflatable bladder is inherently springy and resistant to compression and therefore serves as additional cushioning available to support the body weight of a seat occupant. For this reason, a second layer of foam may be omitted from adjustable seat 30 without sacrificing any cushioning comfort. The elimination of the second layer of foam permits seat back 32 and seat bottom 34 to have a substantially thinner profile than conventional seat backs and seat bottoms.

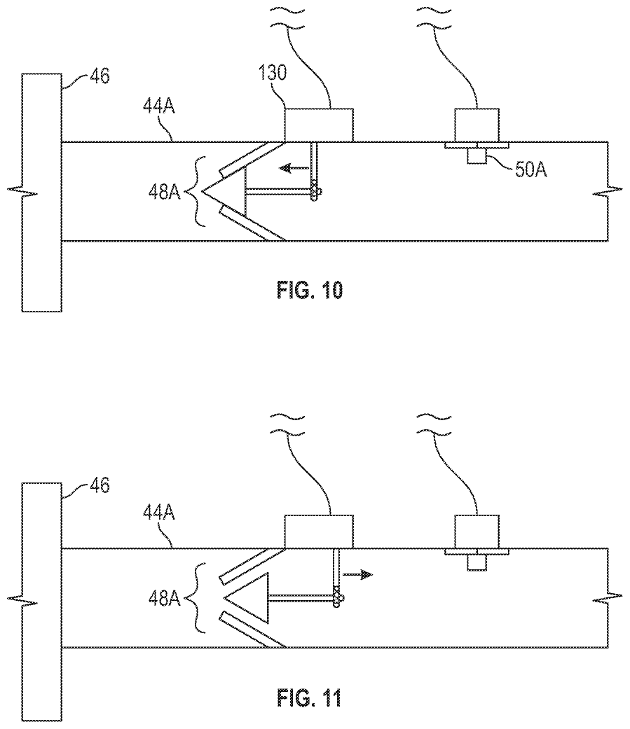

With continuing reference to FIGS. 1-9, FIG. 10 is a fragmentary, schematic view illustrating a portion of conduit 44A. Conduit 44A is one conduit of plurality of conduits 44. In this illustration, a valve 48A has been illustrated. Although valve 48A has been illustrated as being within conduit 44A, it should be understood that in other embodiments, valve 48A may be external to, inline with, or in some other way associated with and/or situated so as to measure the internal air pressure of conduit 44A. Valve 48A is one valve of plurality of valves 48. In FIG. 10, valve 48A is illustrated in a closed position. While in a closed position, air cannot move through valve 48A. Pump 46 is fluidly coupled with conduit 44A and is configured to direct compressed air into conduit 44A. An actuator 130 is associated with valve 48A and is configured to move valve 48A between the closed position illustrated in FIG. 10 and an open position illustrated in FIG. 11, as discussed below. Actuator 130 is communicatively coupled with controller 52 (not shown in FIG. 10). Downstream of valve 48A is pressure sensor 50A. Pressure sensor 50A is one pressure sensor of plurality of pressure sensors 50. Pressure sensor 50A is disposed within conduit 44A and is configured to detect the static pressure within conduit 44A. Pressure sensor 50A is communicatively coupled with controller 52 and is configured to transmit static pressure measurements to controller 52, as discussed above.

With continuing reference to FIGS. 1-10, FIG. 11 is a fragmentary, schematic view similar to the view presented in FIG. 10. In FIG. 11, actuator 130 has moved valve 48A to an open position. With valve 48A in the open position, compressed air may now move through conduit 44A to permit either inflation or deflation of a respective inflatable bladder or a respective cell of inflatable bladders.

With continuing reference to FIGS. 1-11, FIG. 12 is a perspective view illustrating a non-limiting embodiment of an inflatable bladder 42 suitable for use with adjustable seat 30. Sides 140 have a folded accordion-like or convoluted structure that permits inflatable bladder 42 to extend vertically along its longitudinal axis 142 when it is inflated. As illustrated, inflatable bladder 42 has a square-like configuration when viewed from an overhead position. Said another way, a cross-section taken laterally through inflatable bladder 42 along a plane that is oriented perpendicular to longitudinal axis 142 would have a squarish configuration.

In some embodiments, inflatable bladder 42 may include a plurality of feet disposed at an underside of inflatable bladder 42 to stand inflatable bladder 42 off from a surface such as support substrate 120. In such embodiments, plurality of conduits 44 may be routed beneath each inflatable bladder 42 of plurality of inflatable bladders 42 to make efficient use of available packaging space within seat back 32 and seat bottom 34.

With continuing reference to FIGS. 1-12, FIG. 13 is a side view illustrating inflatable bladder 42 in a fully deflated state. When in the fully deflated state, inflatable bladder 42 stands at nominal height 144 and the convoluted structure of side 140 is in a contracted state.

With continuing reference to FIGS. 1-13, FIG. 14 is a side view illustrating inflatable bladder 42 in its fully inflated state. As used herein, the term “fully inflated” means a state of inflation wherein the folded, accordion-like or convoluted structure of side 140 are fully unfolded/extended and no further unfolding of such structure is possible. When in its fully inflated state, inflatable bladder 42 stands at its fully inflated height 146.

In the illustrated embodiment, fully inflated height 146 is at least twice nominal height 144. In other embodiments, the ratio of inflation may exactly twice nominal height 144, while in other embodiments, the ratio of inflation may be between one and a half to two times nominal height 144. In the illustrated embodiment, when inflatable bladder is fully inflated, sides 140 expand slightly in a lateral direction, but such expansion is less than a tenth of the expansion of inflatable bladder 42 along longitudinal axis 142. In other embodiments, there may actually be a diminution in the lateral dimension of the inflatable bladder when it is fully inflated. As used in connection with inflatable bladder 42, the lateral direction refers to a plane that is perpendicular to longitudinal axis 142. As further illustrated in FIG. 14, an upper surface 148 expands slightly in an upward direction and takes on a dome-like contour when inflatable bladder 42 is in its fully inflated state.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the disclosure as set forth in the appended claims.

What is claimed is:

1. An adjustable seat comprising:
a seat body;
a plurality of inflatable bladders coupled with the seat body, each inflatable bladder of the plurality of inflatable bladders having a rectangular cross-section in a direction perpendicular to a longitudinal axis of the inflatable bladder;
a source of a pressurized air fluidly coupled with the plurality of inflatable bladders;
a user input device configured to receive an input from a user; and
a controller communicatively coupled with the user input device and operatively coupled with the source of the pressurized air, the controller configured to obtain the input from the user input device and to control the source of the pressurized air to direct the pressurized air into the plurality of inflatable bladders in response to receiving the input.

2. The adjustable seat of claim 1, wherein each inflatable bladder of the plurality of inflatable bladders has a rectangular cross-section along the entire longitudinal axis of the inflatable bladder.

3. The adjustable seat of claim 1, wherein the rectangular cross-section of each inflatable bladder comprises a squarish cross-section.

4. The adjustable seat of claim 1, wherein each inflatable bladder of the plurality of inflatable bladders is configured to expand such that a longitudinal dimension of each inflatable bladder increases by a factor of two.

5. An adjustable seat comprising:
a seat body;
a plurality of inflatable bladders coupled with the seat body, each inflatable bladder of the plurality of inflatable bladders having a rectangular cross-section in a direction perpendicular to a longitudinal axis of the inflatable bladder;
a source of a pressurized air;
a plurality of conduits fluidly coupling the source of the pressurized air with the plurality of inflatable bladders;
a user input device configured to receive an input from a user;
a sensor configured to detect a change in a weight distribution of a seat occupant along the seat body; and
a controller communicatively coupled with the user input device and with the sensor and operatively coupled with the source of the pressurized air and with the plurality of conduits, the controller configured to:
obtain the input from the user input device and to control the source of the pressurized air to direct the pressurized air into the plurality of inflatable bladders in response to receiving the input, and
obtain information from the sensor indicative of the change in weight distribution of the seat occupant, to select a selected inflatable bladder from the plurality of inflatable bladders based on the information, and to control the source of the pressurized air and the plurality of conduits to change an internal air pressure of the selected inflatable bladder in response to receiving the information.

6. The adjustable seat of claim 5, wherein the controller is configured to identify a designated inflatable bladder of the plurality of inflatable bladders based on the input from the user input device and to control the source of the pressurized air and the plurality of conduits to direct the pressurized air into the designated inflatable bladder in response to receiving the input.

7. The adjustable seat of claim 5, wherein a conduit of the plurality of conduits is fluidly coupled with multiple inflatable bladders thereby defining a cell of inflatable bladders, wherein each inflatable bladder of the cell is inflated in unison with each other inflatable bladder of the cell when the controller directs pressurized air into the one conduit.

8. The adjustable seat of claim 7, wherein the plurality of inflatable bladders comprises a plurality of the cells of inflatable bladders, and wherein the plurality of cells of inflatable bladders corresponds with the plurality of conduits.

9. The adjustable seat of claim 8, wherein the controller is configured to select a selected cell from the plurality of cells based on the information, and to control the source of the pressurized air and the plurality of conduits to change the internal air pressure of the selected cell in response to receiving the information.

10. The adjustable seat of claim 8, wherein the controller is configured to identify a designated cell of the plurality of cells based on the input from the user input device and to control the source of the pressurized air and the plurality of conduits to change the internal air pressure of the designated cell in response to receiving the input.

11. The adjustable seat of claim 5, further comprising a plurality of valves associated with one of the controller, the plurality of conduits, and the plurality of inflatable bladders, each valve of the plurality of valves configured to move between an open position and a closed position, each valve configured to permit the passage of air into and out of the plurality of inflatable bladders when the valve is in the open position and to inhibit the passage of air into and out of the plurality of inflatable bladders when the valve is in the closed position,
wherein the controller is operatively coupled with the plurality of valves and is configured to control movement of the plurality of valves from the open position to the closed position and is further configured to control inflation and deflation of the plurality of inflatable bladders by controlling the plurality of valves to move between the open position and the closed position.

12. The adjustable seat of claim 11, wherein the controller is configured to inflate a first selected inflatable bladder disposed in a first portion of the seat body where the weight distribution of the seat occupant has decreased, and to deflate a second selected inflatable bladder disposed in a second portion of the seat body where the weight distribution of the seat occupant had increased.

13. The adjustable seat of claim 11, wherein the plurality of valves corresponds in number with the plurality of conduits.

14. The adjustable seat of claim 11, further comprising a plurality of the sensors, wherein each sensor of the plurality of the sensors is coupled with each valve of the plurality of valves.

15. The adjustable seat of claim 14, wherein each sensor of the plurality of sensors comprises a pressure sensor.

16. The adjustable seat of claim 5, wherein the controller is configured to control the source of the pressurized air and the plurality of conduits to change the internal air pressure of the selected inflatable bladder only when the change in weight distribution exceeds a predetermined amount of weight that is redistributed within a predetermined amount of time.

17. The adjustable seat of claim 5, wherein the controller is further configured to control the source of the pressurized air and the plurality of conduits to inflate and deflate the plurality of inflatable bladders in a rhythmic pattern in response to receiving a second input from the user input device.

18. The adjustable seat of claim 5, wherein the seat body comprises a supporting substrate, a cushion body disposed above the supporting substrate, and an outer skin disposed over the cushion body, and wherein the plurality of inflatable bladders is disposed between the supporting substrate and the cushion body.

19. The adjustable seat of claim 5, wherein each inflatable bladder of the plurality of inflatable bladders is configured to expand in height when inflated by a factor of two as compared with a nominal height of each inflatable bladder.

20. The adjustable seat of claim 5, wherein each inflatable bladder of the plurality of inflatable bladders has a rectangular cross-section along the entire longitudinal axis of the inflatable bladder.
